(19) United States
(12) Patent Application Publication
(10) Pub. No.: US 2024/0049795 A1
(43) Pub. Date: Feb. 15, 2024

(54) AEROSOL-GENERATING DEVICE WITH AIR-PERMEABLE RECEIVING CAVITY

(71) Applicant: Philip Morris Products S.A., Neuchatel (CH)

(72) Inventors: Rui Nuno Rodrigues Alves BATISTA, Morges (CH); Valerio OLIANA, Pully (CH); Alexandra SEREDA, Zurich (CH); Gianluca BONGIOVANNI, Colombier (CH); Bekele Alemu BEDASSO, Neuchatel (CH)

(73) Assignee: Philip Morris Products S.A., Neuchatel (CH)

(21) Appl. No.: 18/256,964

(22) PCT Filed: Dec. 6, 2021
(86) PCT No.: PCT/EP2021/084450

§ 371 Date: Jun. 12, 2023

(30) Foreign Application Priority Data
Dec. 17, 2020 (EP) 20215085.0

(51) Int. Cl. A24F 40/465; A24F 40/48; A24F 40/20; H05B 6/10

(52) U.S. Cl. CPC A24F 40/465; A24F 40/48; A24F 40/20; H05B 6/105

(57) ABSTRACT

An aerosol-generating device for generating an aerosol from an aerosol-forming substrate is provided, the aerosol-generating device including: a cavity having an opening configured to receive the aerosol-forming substrate, the cavity being defined by side walls extending away from the opening; a cavity base configured to support the aerosol-forming substrate, or an aerosol-generating article including the aerosol-forming substrate, when received in the cavity, the cavity base being arranged to be longitudinally movable within the side walls defining the cavity; a push rod configured to move the cavity base, the push rod protruding from a body of the aerosol-generating device when the aerosol-forming substrate, or the aerosol-generating article including the aerosol-forming substrate, is positioned within the cavity; and at least one induction coil located external to the cavity and arranged to generate a fluctuating magnetic field. An aerosol-generating system including the aerosol-generating device and an aerosol-generating article is also provided.

The present disclosure relates to an aerosol-generating device for generating an aerosol. The present disclosure also relates to an aerosol-generating system.

Aerosol-generating devices configured to generate an aerosol from an aerosol-forming substrate, such as a tobacco-containing substrate, are known in the art. Such known devices may generate aerosol from the substrate through the application of heat to the substrate, rather than combustion of the substrate. The aerosol-forming substrate may be present as a component part of an aerosol-generating article, in which the article is physically separate from the aerosol-generating device. Such an aerosol-generating article may be received in a cavity of the aerosol-generating device.

In use, the device may provide power to enable the transfer of heat from a heat source to the aerosol-forming substrate. During use of such known aerosol-generating devices, volatile compounds are released from the aerosol-forming substrate by heat transfer from the heat source and entrained in air drawn through the aerosol-generating article. As the released compounds cool, they condense to form an aerosol that is inhaled by the consumer.

Many aerosol-generating devices provide heat to the outside of an aerosol-generating article or aerosol-forming substrate. External heating devices implementing inductive heating have metallic tubular susceptor elements as cavities for receiving consumables, such as aerosol-generating articles. Such systems require tight contact of the susceptor element with the consumables, to enable effective thermal transfer as well as to assure adequate air management. This creates complexity in the production of the consumables in terms of its diameter, with very tight tolerances, to assure a correct fit inside the susceptor cavity of the device. Such tight tolerances means that consumables may become stuck inside the device, as the consumables are naturally moisturized during consumption. Thus, it is very difficult to take the consumables out of such a tubular susceptor element/cavity. For extraction of fragmented consumables inside such cavities, specific tools are needed, and care needs to be taken so as to not damage the shape and surface of the susceptor.

According to the present disclosure, there is provided an aerosol-generating device for generating an aerosol from an aerosol-forming substrate. The aerosol-generating device comprises a cavity having an opening for receiving the aerosol-forming substrate. The cavity may be defined by side walls extending away from the opening. At least one induction coil may be located external to the cavity and arranged to generate, in operation, a fluctuating magnetic field within the cavity. The side walls of the cavity may be formed from a non-magnetic material. The side walls of the cavity are permeable to air thereby allowing a radial influx of air into the cavity through the side walls.

According to a first aspect of the present disclosure, there is provided an aerosol-generating device for generating an aerosol from an aerosol-forming substrate. The aerosol-generating device comprises a cavity having an opening for receiving the aerosol-forming substrate. The cavity is defined by side walls extending away from the opening. At least one induction coil is located external to the cavity and arranged to generate, in operation, a fluctuating magnetic field within the cavity. The side walls of the cavity are formed from a non-magnetic material. The side walls of the cavity are permeable to air thereby allowing a radial influx of air into the cavity through the side walls.

Existing induction heating devices for external heating of an aerosol-forming article have tubular susceptor cavities. In addition to the problems noted above, the use of a tubular susceptor cavity further limits use of the device in terms of diversity of consumables that can be used with it. For example, different aerosol-generating articles and consumables may require different air management set-ups. Existing devices also do not facilitate customization of consumer experiences in terms of the use of a plurality of different types of aerosol generating consumables in a combined way.

In the present disclosure, the aerosol-generating device comprises a cavity for receiving a consumable, such as an aerosol-generating article or a cartridge containing an aerosol-generating article or an aerosol-forming substrate. Preferably, an inductor located external to the cavity generates a fluctuating electromagnetic field within the cavity for inductively heating a susceptor located in the aerosol-generating article or as part of a cartridge that is receivable within the cavity. The side walls of the cavity are formed from a non-magnetic material to minimise or eliminate interaction with the fluctuating electromagnetic field. Thus, the device can be configured as an inductively heated device, but in which the cavity of the device itself does not heat the aerosol-forming substrate. The device may be configured as an inductively heated device in which the susceptor is an element that is received within the cavity.

The side walls of the cavity may be formed from any suitable non-magnetic material, preferably a material or materials possessing suitable chemical and UV stability.

The side walls of the cavity may be formed from a non-susceptor material. A non-susceptor material is a material that does not undergo any substantial interaction or coupling with the fluctuating electromagnetic field. A non-susceptor material does not heat up within the fluctuating electromagnetic field. The side walls of the cavity may be formed from a polymeric material, for example a polypropylene or polyethylene or polycarbonate. The side walls may be formed from a ceramic material or a glass material. The side walls may be formed from a composite material, for example a polymer matrix composite material.

The side walls of the cavity may be formed from a non-magnetic metallic material. Such a material may have minimal coupling with the fluctuating electromagnetic field. Thus, heating of the cavity walls may be minimal or non-existent. The side walls of the cavity may be formed from a metal selected from the list consisting of aluminium, aluminium alloys, brass, copper, copper alloys, and non-ferromagnetic stainless steels.

As used herein, the term “aerosol” refers to a dispersion of solid particles, or liquid droplets, or a combination of solid particles and liquid droplets, in a gas. The aerosol may be visible or invisible. The aerosol may include vapours of substances that are ordinarily liquid or solid at room temperature as well as solid particles, or liquid droplets, or a combination of solid particles and liquid droplets.

As used herein, the term “aerosol-forming substrate” refers to a substrate capable of releasing volatile compounds that can form an aerosol. The volatile compounds may be released by heating or combusting the aerosol-forming substrate.

The aerosol-forming substrate may be a solid aerosol-forming substrate. The solid aerosol-forming substrate may comprise one or more of: powder, granules, pellets, shreds, strands, strips or sheets containing one or more of: herb leaf, tobacco leaf, tobacco ribs, expanded tobacco and homogenised tobacco.

The aerosol-forming substrate may comprise solid and liquid components. The aerosol-forming substrate may be a liquid, gel or paste aerosol-forming substrate.

The aerosol-forming substrate may be provided on or embedded in a thermally stable carrier. The carrier may take the form of powder, granules, pellets, shreds, strands, strips or sheets. The solid aerosol-forming substrate may be deposited on the surface of the carrier in the form of, for example, a sheet, foam, gel or slurry. The aerosol-forming substrate may be deposited on the entire surface of the carrier, or alternatively, may be deposited in a pattern in order to provide a non-uniform flavour delivery during use.

The aerosol-forming substrate may comprise nicotine. The aerosol-forming substrate may comprise plant-based material. The aerosol-forming substrate may comprise homogenised plant-based material. The aerosol-forming substrate may comprise tobacco. The aerosol-forming substrate may comprise a tobacco-containing material. The tobacco-containing material may contain volatile tobacco flavour compounds. These compounds may be released from the aerosol-forming substrate upon heating. The aerosol-forming substrate may comprise homogenised tobacco material. The aerosol-forming substrate may comprise other additives and ingredients, such as flavourants.

The aerosol-forming substrate may comprise homogenised tobacco material. As used herein, the term “homogenised tobacco material” refers to a material formed by agglomerating particulate tobacco.

The aerosol-forming substrate may comprise a gathered sheet of homogenised tobacco material. As used herein, the term “sheet” refers to a laminar element having a width and length substantially greater than the thickness thereof. As used herein, the term “gathered” is used to describe a sheet that is convoluted, folded, or otherwise compressed or constricted substantially transversely to the longitudinal axis of the aerosol-generating article.

The aerosol-forming substrate may comprise an aerosol former. As used herein, the term “aerosol former” is used to describe any suitable known compound or mixture of compounds that, in use, facilitates formation of an aerosol and that is substantially resistant to thermal degradation at the operating temperature of the aerosol-generating article. Suitable aerosol-formers are known in the art and include, but are not limited to: polyhydric alcohols, such as propylene glycol, triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. Preferred aerosol formers are polyhydric alcohols or mixtures thereof, such as propylene glycol, triethylene glycol, 1,3-butanediol and, most preferred, glycerine.

The aerosol-forming substrate may comprise a single aerosol former. For example, the aerosol-forming substrate may comprise glycerine as the only aerosol former, or propylene glycol as the only aerosol former. Alternatively, the aerosol-forming substrate may comprise a combination of two or more aerosol formers. For example, the aerosol former component of the aerosol-forming substrate may be glycerine and propylene glycol.

As used herein, the term “aerosol-generating article” or “consumable” refers to an article comprising, or consisting of, an aerosol-forming substrate. An aerosol-generating article or consumable may comprise components in addition to the aerosol-forming substrate. The aerosol-generating article or consumable may be a smoking article. The aerosol-generating article or consumable may generate an aerosol that is directly inhalable into a user's lungs through the user's mouth. The aerosol-generating article or consumable may be a smoking article that generates a nicotine-containing aerosol that is directly inhalable into a user's lungs through the user's mouth. The aerosol-generating article or consumable may be in the form of a rod.

As used herein, the term “cartridge” refers to a component that may be removably received by an aerosol-generating device. The cartridge locates or contains an aerosol-generating article or consumable comprising or consisting of an aerosol-forming substrate.

As used herein, the term “susceptor cartridge” refers to a cartridge comprising a susceptor for heating an aerosol-forming substrate to generate an aerosol.

As used herein, the term “aerosol-generating device” refers to a device that interacts with an aerosol-forming substrate to generate an aerosol. An aerosol-generating device may interact with an aerosol-generating article comprising an aerosol-forming substrate, or with a cartridge holding an aerosol-forming substrate or aerosol-generating article, to generate an aerosol. The aerosol-generating device may heat the aerosol-forming substrate to facilitate release of volatile compounds from the substrate. The aerosol-generating device may be an electrically operated aerosol-generating device. The aerosol-generating device may comprise an atomiser, such as an electric heater, to heat the aerosol-forming substrate to form an aerosol. The aerosol-generating device comprises a cavity for receiving an aerosol generating article or a cartridge. The aerosol-generating device preferably comprises an inductor for generating a fluctuating electromagnetic field within the cavity.

As used herein, the terms “axial” and “longitudinal” are used to describe a direction between a downstream, proximal or mouth end of a component, such as an aerosol-generating device, cartridge or aerosol-generating article, and an opposed, upstream or distal end of the component.

As used herein, the terms “radial” and “transverse” are used to describe a direction perpendicular to the longitudinal direction.

As used herein, the term “length” is used to describe a maximum longitudinal dimension between a distal or upstream end of a component, such as an aerosol-generating device, cartridge or aerosol-generating article, and an opposed, upstream or distal end of the component.

As used herein, the term “width” is used to describe a transverse dimension of a component, such as an aerosol-generating device, cartridge or aerosol-generating article.

As used herein, the term “diameter” is used to describe a maximum transverse dimension of a component, such as an aerosol-generating device, cartridge or aerosol-generating article.

Preferably, at least a portion of the side walls of the cavity are formed from a radially-porous material. The ability to allow a radial influx of air into the cavity enables different configurations of consumable to be used with the device.

The side walls may have a longitudinal dimension extending away from the opening of the cavity. Between 50% and 100% of the longitudinal dimension of the side walls may be formed from a radially porous material. Substantially all of the side walls may be formed from a radially-porous material. The radially-porous material may be in the form of a mesh or a net. The radially-porous material is preferably in the form of a tube, for example a ridged tube, for example a ridged tubular polymeric mesh. Radial porosity may be formed by holes defined through portions of the side walls.

The side walls may have a total porosity of between 40% and 95%, preferably between 50% and 90%, preferably between 60% and 80%.

The cavity of the device may be substantially cylindrical, for example substantially circular cylindrical. The side walls of the cavity may be substantially tubular. Thus, the cavity may be able to receive a substantially cylindrical shaped aerosol-generating article or a substantially cylindrical cartridge. A transverse cross-section of the cavity may be substantially circular, although other shapes of transverse cross-section are possible, for example oval, or polygonal shapes such as square, or rectangular, or hexagonal. The cavity of the device may have a length of between 20 mm and 100 mm. The cavity may, for example, have a length of at least 20, 30, 40 or 50 millimetres. The cavity may have a length of less than 100, 80, or 60 millimetres. The cavity may have a width of between 3 mm and 30 mm. The cavity may have a width of at least 3, 5 or 10 millimetres. The cavity may have a width of less than 30, 20 or 15 millimetres.

The aerosol-generating device may comprise a housing, the cavity being located by or located within the housing. Preferably, one or more air inlets are defined in the housing to allow an air flow path to the cavity. Preferably, one or more air flow paths extend from one or more air inlets to an outer surface of the side walls of the cavity, radial inflow of air thus being allowed into the cavity. The housing may comprise the side walls.

The device may comprise a cavity base for supporting the aerosol-forming substrate, or an aerosol-generating article comprising the aerosol-forming substrate, when received in the cavity. The cavity base may be arranged to be longitudinally-movable within the side walls of the cavity. For example, the cavity base may be similar to a plunger or piston arranged to move longitudinally within the cavity. The cavity base may be longitudinally-movable between a first position and a second position, in which in the first position the cavity base is positioned closer to the opening of the cavity than in the second position. Movement of the cavity base within the cavity may, therefore, facilitate removal of an aerosol-generating article or a cartridge received within the cavity by allowing the article or cartridge to be at least partially pushed out of the opening of the cavity. The housing may comprise the cavity base.

The cavity base may be biased by a biasing element. For example, the cavity base may be biased by a spring. The biasing element or spring may urge the cavity base in a direction towards the opening of the cavity. Such a biasing element may help facilitate movement of the base and extraction of an aerosol-generating article or cartridge from the cavity.

The aerosol-generating device may comprise a latch or latching means for releasably retaining the cavity base in its first position. The aerosol-generating device may comprise a latch or latching means for releasably retaining the cavity base in its second position. The cavity base may, therefore, be stable in one or both of its first position and second position when latched and able to move from that position when the latch is released.

The first position of the cavity base may be defined by a stop which acts to prevent further movement of the cavity base towards the cavity opening. For example, the stop may comprise a ledge defined by, or within, the side walls, or a projection extending radially from the side walls.

The side walls of the cavity may have a proximal end towards the opening of the cavity and a distal end. The distal end of the side walls may terminate in an end face or a cap. The cavity base may be located proximally to the end face or cap. A hole may be defined through the end face or cap.

The side walls may be integral with the housing of the device. The side walls may be connected to the housing of the device. The side walls may be releasably or permanently connected to the housing of the device.

The cavity base may have a first surface facing the cavity opening and a second surface facing away from the cavity opening. The second surface may be coupled with or connected to a push rod, the push rod extending away from the second surface. The push rod may be dimensioned to extend through the hole in the end face or cap. Thus, movement of the cavity base may be effected by acting on the push rod. The push rod may protrude from a body of the aerosol-generating device when an aerosol-forming substrate, or an aerosol-generating article comprising the aerosol-forming substrate, or a cartridge comprising an aerosol-generating article or an aerosol-forming substrate, is positioned within the cavity. The cavity base and push rod may form a manually actuatable ejector for facilitating removal of the aerosol-forming substrate, aerosol-generating article, or cartridge, from the cavity.

The aerosol-generating device may further comprise a removable mouthpiece, the removable mouthpiece being removeably attachable to the aerosol-generating device in a position covering the opening of the cavity. The removable mouthpiece may be removed to allow an aerosol-generating article or a cartridge to be inserted into the device. Alternatively, the aerosol-generating article or the cartridge may comprise a mouthpiece.

Preferably, the aerosol-generating device is configured to receive an aerosol-generating article, or a cartridge, comprising the aerosol-forming substrate and a susceptor for interacting with a fluctuating electromagnetic field generated by at least one induction coil to heat the aerosol-forming substrate. The at least one induction coil may be adjacent to the cavity. The at least one induction coil may radially encircle a portion of the cavity.

The aerosol-generating device may comprise an inductor, such as an induction coil and a power source. The power source may be configured to pass an alternating current through the inductor such that the inductor generates a fluctuating or oscillating electromagnetic field. The alternating current may have any suitable frequency. The alternating current may be a high frequency alternating current. The alternating current may have a frequency between 100 kilohertz (kHz) and 30 megahertz (MHz). Where the inductor is a tubular inductor coil, the alternating current may have a frequency of between 500 kilohertz (kHz) and 30 megahertz (MHz). Where the inductor is a flat inductor coil, the alternating current may have a frequency of between 100 kilohertz (kHz), and 1 megahertz (MHz).

The aerosol-generating device may comprise a first induction coil and a second induction coil, both the first induction coil and the second induction coil being arranged to generate, in operation, a fluctuating magnetic field within the cavity. The first induction coil may be arranged to generate a fluctuating magnetic field within a first portion of the cavity and the second induction coil may be arranged to generate a fluctuating magnetic field within a second portion of the cavity. In this manner, the first induction coil and the second induction coil may be arranged to heat susceptors, or portions of a susceptor or susceptors, located within different portions of the cavity.

The first induction coil may be configured to generate a first fluctuating magnetic field within the cavity, the first fluctuating magnetic field having first magnetic field properties, and the second induction coil may be configured to generate a second fluctuating magnetic field within the cavity, the second fluctuating magnetic field having second magnetic field properties, the second magnetic field properties being different to the first magnetic field properties. The device may be configured to control the first and second induction coils to provide control of heating of a susceptor within the cavity, or to allow the device to be configured to operate with different types of susceptor located within the cavity. For example, the device may be configured to heat a first type of susceptor located within an aerosol-generating article and a second type of susceptor located within a removable cartridge, both the aerosol-generating article and the removable cartridge being dimensioned to be received within the cavity. By using more than one induction coil, the device be able to heat susceptors of different sizes and shapes, for example both rod or blade shaped susceptors and tubular susceptors. The aerosol-generating device may thus be configured for use with a greater variety of consumables, providing a user with greater choice.

The aerosol-generating device preferably comprises at least one power source, for example a power source for supplying power to at least one induction coil of the device. The device preferably comprises at least one controller, for example a controller configured to control power supply to at least one induction coil.

The aerosol-generating device may comprise a detector or detection means for detecting the presence of the aerosol-forming substrate, a cartridge, or an aerosol-generating article comprising the aerosol-forming substrate, within the cavity.

The device may be configured to operate with a first type of aerosol-generating article or cartridge and a second type of aerosol-generating article or cartridge different from the first type of aerosol-generating article or cartridge, in which the first type of aerosol-generating article or cartridge comprises an aerosol-forming substrate and a first susceptor configuration for heating the aerosol-forming substrate, and the second type of aerosol-generating article or cartridge comprises an aerosol-forming substrate and a second susceptor configuration for heating the aerosol-forming substrate. The first susceptor configuration and the second susceptor configuration may differ in one or more susceptor parameters selected from the list consisting of susceptor material, susceptor shape, susceptor dimensions, and susceptor position relative to the aerosol-forming substrate.

The device may be configured to detect which of the first type of aerosol-generating article and the second type of aerosol-generating article has been received in the cavity. The device may be configured to control at least one induction coil to produce a fluctuating magnetic field suitable for heating the susceptor of that type of aerosol-generating article.

According to an aspect of the present disclosure, there is provided an aerosol-generating system comprising an aerosol-generating device as defined above and an aerosol-generating article or cartridge configured to be received within the cavity of the aerosol-generating device, the aerosol-generating article or cartridge comprising;
an aerosol-forming substrate, and a susceptor for heating the aerosol-forming substrate when coupled with a fluctuating magnetic field generated by the induction coil of the aerosol-generating device.

The susceptor may be, or may comprise, any material that can be inductively heated to a temperature sufficient to generate an aerosol from the aerosol-forming substrate. Preferred susceptor materials may be heated to a temperature in excess of 50, 100, 150, 200, 250, 300, 350, or 400 degrees Celsius. Preferred susceptor materials may comprise a metal suitable for coupling with the fluctuating electromagnetic field. A preferred susceptor material may comprise a ferromagnetic material, for example ferritic iron, or a ferromagnetic steel or stainless steel, or nickel, or cobalt. Preferred susceptor materials may comprise, or be formed from, 400 series stainless steels, for example grade 410, or grade 420, or grade 430 stainless steel. Different materials will dissipate different amounts of energy when positioned within electromagnetic fields having similar values of frequency and field strength. Thus, parameters of the susceptor material such as material type and size may be altered to provide a desired power dissipation within a known electromagnetic field.

The aerosol-generating article or cartridge may be in the form of a rod having a proximal end and a distal end, the distal end of the rod being dimensioned to be received in the cavity of the aerosol-generating device, the aerosol-forming substrate being located within the rod.

One or more susceptors may be located internally within the rod for heating the aerosol-forming substrate. For example, one or more susceptors may be located radially centrally within the rod, or one or more susceptors may be located at a radially outward portion of the rod. One or more susceptors may encircle a portion of the rod. An outer layer of the rod may comprise one or more susceptors. The one or more susceptors may be located in contact with the aerosol-forming substrate. The one or more susceptors may be a component part of a disposable aerosol-generating article, for example an aerosol-generating article dimensioned to be received in the cavity of the aerosol-generating device or within a reusable cartridge that is dimensioned to be received in the cavity of the aerosol-generating device.

The aerosol-generating article or cartridge may define an air flow path extending between a distal end of the aerosol-generating article or cartridge and a proximal end of the aerosol-generating article or cartridge. The aerosol-generating article or cartridge may define an air flow path in which at least a portion of an air flow path through the article extends between radial air inlets located between a distal end of the aerosol-generating article or cartridge and a proximal end of the aerosol-generating article or cartridge and an air outlet at the distal end of the aerosol-generating article or cartridge. Air may flow into radial air flow inlets of the article or cartridge through air permeable walls of the aerosol-generating device cavity.

An aerosol-generating article or cartridge suitable for use with the system may be an elongated aerosol-generating article comprising an aerosol-forming substrate located within a housing or wrapper, and in which one or more holes or regions of porosity defined through the housing or wrapper allow radial air flow into the aerosol-generating article.

The aerosol-forming substrate may be a solid aerosol-forming substrate, for example an aerosol-forming substrate consisting of or comprising tobacco material. The aerosol-forming substrate may be or comprise a liquid aerosol-forming substrate, for example an aerosol-forming substrate comprising glycerine or propylene glycol.

An aerosol-generating article suitable for use with the system may be a disposable aerosol-generating article configured to be disposed of after a single use. The aerosol-generating article may comprise a plurality of components including the aerosol-forming substrate assembled within a wrapper in the form of a rod. The aerosol-generating article may comprise a susceptor located within the wrapper. The wrapper of the aerosol-generating article may comprise or consist of a susceptor.

An aerosol-generating article or cartridge element suitable for use with the system may comprise a reusable portion and a disposable portion. The reusable portion may be in the form of a cartridge configured to be received in the cavity. The cartridge may have a housing comprising a susceptor material and defining a cartridge cavity for receiving an aerosol-forming substrate. The disposable portion may be an article or consumable comprising the aerosol-forming substrate. The cartridge cavity may be configured to receive one or more separate consumables.

The reusable portion or cartridge may have a longitudinal dimension and a radial dimension, and one or more holes or regions of porosity may be defined through walls of the housing to form one or more radial air inlets into the cartridge cavity.

The cartridge housing may define an axial air inlet. The axial air inlet may allow air to flow into the housing in an axial direction. The housing may define an air outlet. The air outlet may be downstream of the axial air inlet. The air outlet may be an axial air outlet. The air outlet may allow air to flow out of the housing in an axial direction. The housing may define a first air flow path from the axial air inlet to the air outlet. Advantageously, the axial air inlet and axial air outlet may allow the cartridge to be used with consumables configured to have axial air flow therethrough, for example a consumable having an impermeable barrier around its circumference but a permeable barrier, or no barrier, at its axial ends.

The housing of the cartridge may have a proximal, or downstream, end and a distal, or upstream, end. The housing may be, or may comprise, a partially or entirely hollow tube. The tube may be defined between a proximal, or downstream, end and a distal, or upstream, end. The tube may define the cavity for receiving the aerosol-forming substrate.

The cartridge cavity may be suitable for receiving one or more consumable. As stated above, the term “consumable” may refer to an article comprising, or consisting of, an aerosol-forming substrate. The cavity may be suitable for receiving multiple consumables. Advantageously, the ability to hold multiple consumables may allow a user to customise their experience by using multiple consumables of different flavours.

Each consumable may have a length spanning an axial direction between an upstream end and a downstream end. Each consumable may have a diameter spanning a transverse direction. The cartridge cavity may be suitable for receiving multiple consumables such that the consumables are arranged axially within the cavity. The cavity may be suitable for receiving multiple consumables such that an upstream end of a first consumable received in the cavity is located adjacent to, and optionally in abutment with, a downstream end of a second consumable received in the cavity. In addition, an upstream end of the second consumable received in the cavity may be located adjacent to, and optionally in abutment with, a downstream end of a third consumable received in the cavity. The cavity may be suitable for receiving multiple consumables such that a first consumable received in the cavity is entirely downstream of a second consumable received in the cavity. In addition, the second consumable received in the cavity may be entirely downstream of a third consumable received in the cavity. Advantageously, allowing this arrangement in the cavity may allow a user to customise their experience by using different orders of consumables of different flavours in the cavity.

The cavity may be configured to securely hold one or more consumables received in the cavity. For example, the cavity may be sized so as to securely hold one or more consumables received in the cavity using an interference fit or friction fit. Advantageously, this may remove the need for a separate mechanism to securely hold consumables in the cavity.

The cartridge housing may define a first radial air inlet. The first radial air inlet may be upstream of the air outlet. The first radial air inlet may be downstream of the axial air inlet. A second air flow path may be defined from the first radial air inlet to the air outlet. The first radial air inlet may allow air to flow into the housing in a radial direction.

The cartridge housing may define a second radial air inlet. The second radial air inlet may be upstream of the air outlet. The second radial air inlet may be axially spaced along the housing from the first radial air inlet. The second radial air inlet may be downstream of the first radial air inlet. A third air flow path may be defined from the second radial air inlet to the air outlet. The second radial air inlet may allow air to flow into the housing in a radial direction.

The cartridge housing may define a third radial air inlet. The third radial air inlet may be upstream of the air outlet. The third radial air inlet may be axially spaced along the housing from the first and second radial air inlets. The third radial air inlet may be downstream of the second radial air inlet. A fourth air flow path may be defined from the third radial air inlet to the air outlet. The third radial air inlet may allow air to flow into the housing in a radial direction.

The first radial air inlet may be positioned so as to align with a first consumable received in the cavity. In use, air may flow through the first radial air inlet then through the first consumable, for example through a permeable outer, or circumferential, portion of the first consumable. The air may then flow axially through the housing. Where a second consumable is received in the cavity, air may flow axially through the second consumable after flowing through the first consumable. Where a third consumable is also received in the cavity, air may flow axially through the third consumable after flowing through the second consumable.

The second radial air inlet may be positioned so as to align with a second consumable received in the cavity. In use, air may flow through the second radial air inlet then through the second consumable, for example through a permeable outer, or circumferential, portion of the second consumable. The air may then flow axially through the housing. Where a third consumable is also received in the cavity, air may flow axially through the third consumable after flowing through the second consumable.

The third radial air inlet may be positioned so as to align with a third consumable received in the cavity. In use, air may flow through the third radial air inlet then through the third consumable, for example through a permeable outer, or circumferential, portion of the third consumable. The air may then flow axially through the housing.

Advantageously, the use of radial air inlets in this manner may enhance the user experience as fresh air may flow through each of the consumables. In contrast, where only an axial air inlet is present, air flowing through the second consumable may not be fresh as this air has already flowed through the first consumable. In this context, the term “fresh air” is used to refer to air which has not already flowed through a consumable.

The cartridge housing may define both an axial air inlet and one or more radial air inlets. For example, the housing may define the axial air inlet and any one, two or all of the first, second and third radial air inlets. Any one, two or all of the first, second and third radial air inlets may be located downstream of the axial air inlet. The air outlet may be downstream of the axial air inlet and the radial air inlet(s). The air flow path from the axial air inlet to the air outlet may merge with any one, two, or all of the air flow path(s) from the first, second or third air inlets to the air outlet. Advantageously, the inclusion of an axial air inlet and a radial air inlet may reduce a resistance to draw of the cartridge by allowing a greater flow rate of air into the housing. Advantageously, this may also allow the cartridge to be used with a greater variety of consumables. This is because the cartridge may be suitable for use with consumables intended for axial air flow therethrough and consumables intended for radial air flow therethrough.

Any one, two or all of the first, second and third radial air inlets may be formed by an air-permeable portion of the cartridge housing. Thus, the first radial air inlet may be formed by a first air-permeable portion of the housing. The second radial air inlet may be formed by a second air-permeable portion of the housing. The third radial air inlet may be formed by a third air-permeable portion of the housing.

Any one, two, or all of the first, second and third air-permeable portions of the housing may comprise one or more of a porous material, and a plurality of holes such as a plurality of slits.

Any one, two, or all of the first, second and third air-permeable portions of the housing may have a porosity of between 40% and 95%, or between 50% and 90%, or between 60% and 80%. In this context, the term “porosity” may be used as a measure of free space through a wall of the housing by area. Thus, where an air-permeable portion comprises a plurality of holes surrounded by a solid material, the percentage of the cross-sectional area of the air-permeable portion which is formed by the holes may be between 40% and 95%, or between 50% and 90%, or between 60% and 80% (with the remaining 60% to 5%, or 50% to 10%, or 40% to 20%, being formed by the solid material). Advantageously, these ranges of porosities may provide an optimal comprise between a number of factors, including allowing an appropriate amount of air to flow through the cartridge, allowing a suitable level of heating of the susceptor material of the housing near the air-permeable portions, providing an optimal resistance to draw through the cartridge, and maintaining the structural integrity of the housing.

The first air-permeable portion may comprise a first annular, or substantially annular, air-permeable band in the housing. The first annular, air-permeable band may comprise a first plurality of holes in the housing.

The second air-permeable portion may comprise a second annular, or substantially annular, air-permeable band in the housing. The second annular, air-permeable band may comprise a second plurality of holes in the housing. The second annular air-permeable band may be axially spaced along the housing from the first annular, air-permeable band.

The third air-permeable portion may comprise a third annular, or substantially annular, air-permeable band in the housing. The third annular, air-permeable band may comprise a third plurality of holes in the housing. The third annular air-permeable band may be axially spaced along the housing from the first and second annular, air-permeable bands.

The first air-permeable band may have a first permeability to air flow therethrough. The second air-permeable band may have a second permeability to air flow therethrough. The third air-permeable band may have a third permeability to air flow therethrough. The first permeability may be different to the second permeability. The first permeability may be different to the third permeability. The second permeability may be different to the third permeability. The first air-permeable band, second air-permeable band, and third air-permeable band may all have different permeabilities.

Advantageously, these different permeabilities may allow a user to customise their experience by deciding where to locate consumables in the cartridge based on an expected flow rate of air through the air-permeable bands. For example, where a user wishes to maximise a flavour present in a particular consumable, this consumable may be received in the cavity so as to align with the air-permeable band having the highest permeability.

Any, one, two or all of the first, second and third annular, air-permeable bands of the housing may extend around at least 50, 60, 70, 80, or 90% of the circumference of the housing. Thus, it should be appreciated that the annular, air-permeable bands may, but needn't necessarily, extend around the entire circumference or periphery of the housing.

The cartridge may be a susceptor cartridge useable with an aerosol-generating device configured to inductively heat the susceptor material of the cartridge, for example an aerosol-generating device as described above. For example, the cartridge may be configured to be for use with an aerosol-generating device comprising an inductor, such as an inductor coil. The aerosol-generating device may comprise a power source. The power source may be configured to pass an alternating current through the inductor such that the inductor generates a fluctuating electromagnetic field. The device may be configured such that the cartridge may be located within a fluctuating electromagnetic field. The alternating current may be a high frequency alternating current. This, in turn, may generate eddy currents and hysteresis losses in the susceptor material. This may cause the susceptor material to heat up. Thus, the power source and the inductor may be configured to inductively heat the susceptor material.

The susceptor material may make up more than 50, 60, 70, or 80% of the housing by weight. The housing may consist of, or be formed from, the susceptor material. Advantageously, a higher proportion of the housing being formed of the susceptor material may lead to greater inductive heating of the housing in an inductively heated aerosol-generating system.

The susceptor material may contact the consumable or aerosol-forming substrate in the cavity in use. Advantageously, this may lead to more efficient heat transfer from the susceptor material to the consumable or aerosol-forming substrate in use.

The cartridge cavity may have a length of between 20 mm and 100 mm. The cavity may have a length of at least 20, 30, 40 or 50 millimetres. The cavity may have a length of less than 100, 80, or 60 millimetres. The cavity may have a width of between 3 mm and 30 mm. The cavity may have a width of at least 3, 5 or 10 millimetres. The cavity may have a width of less than 30, 20 or 15 millimetres. The cavity may be substantially cylindrical in shape, for example substantially right cylindrical in shape. The cavity may have a circular transverse cross-section, or an oval transverse cross-section, or a polygonal transverse cross-section.

The cartridge may comprise a reusable mouthpiece. The mouthpiece may comprise or be formed from a polymer or a ceramic. Advantageously, a reusable cartridge may be more environmentally friendly than a disposable cartridge.

An air flow path may be defined through the mouthpiece. In use, air may flow, or be drawn, into the cartridge through the cartridge housing and then through the mouthpiece to a user.

The present disclosure may provide, a method of generating an aerosol using an aerosol-generating device or an aerosol-generating system as described above. The method may comprise steps of locating an aerosol-generating article or a cartridge comprising an aerosol-forming substrate and a susceptor within the cavity of the aerosol-generating device, and operating at least one induction coil of the aerosol-generating device to generate a fluctuating magnetic field within the cavity of the device, the fluctuating magnetic field coupling with the susceptor causing the susceptor to heat to an operating temperature, thereby heating the aerosol-forming substrate to form an aerosol. The method may further comprise the step of drawing on a mouthpiece in fluid communication with the aerosol-forming substrate to inhale the aerosol.

When a user draws on the mouthpiece, which depending on configuration may be the mouthpiece of an aerosol-generating article, a mouthpiece of a cartridge, or a mouthpiece of the aerosol-generating device, air is preferably drawn into the aerosol-generating device through an air inlet defined in a housing of the device and into the cavity of the device. In preferably configurations air is drawn into the cavity of the device through an air-permeable region in the side walls of the cavity. Air then passes over a heated aerosol-forming substrate, entraining volatile compounds and towards the mouth of the user. Aerosol forms in the airflow and is inhaled by the user.

The method may comprise the further step of ejecting the aerosol-generating article or cartridge from the aerosol-generating device after use.

The cavity of the device may comprise a cavity base longitudinally-movable between a first position and a second position, in which in the first position the cavity base is positioned closer to the opening of the cavity than in the second position. The method may then comprise steps of inserting the aerosol-generating article into the cavity until it contacts the cavity base, applying pressure to move the cavity base from the first position to the second position, the second position being an operating position, and retaining the cavity base in the second position during generation of the aerosol. The method may then comprise the step of ejecting the aerosol-generating article from the aerosol-generating device by moving the cavity base from the second position to the first position, the first position being an ejection position, thereby causing the aerosol-generating article to move in a direction towards the cavity opening.

The present disclosure includes the following numbered examples.
Example Ex1. An aerosol-generating device for generating an aerosol from an aerosol-forming substrate, the aerosol-generating device comprising;
a cavity having an opening for receiving the aerosol-forming substrate,
the cavity being defined by side walls extending away from the opening; and
at least one induction coil located external to the cavity and arranged to generate, in operation, a fluctuating magnetic field within the cavity;
in which the side walls of the cavity are formed from a non-magnetic material, and
in which the side walls of the cavity are permeable to air thereby allowing a radial influx of air into the cavity through the side walls.
Example Ex2. An aerosol-generating device according to example Ex1 in which the side walls of the cavity are formed from a non-susceptor material.
Example Ex3. An aerosol-generating device according to example Ex1 or Ex2 in which the side walls of the cavity are formed from a polymeric material.
Example Ex4. An aerosol-generating device according to example Ex1 or Ex2 in which the side walls are formed from a ceramic material or a glass material.
Example Ex5. An aerosol-generating device according to example Ex1 or Ex2 in which the side walls are formed from a composite material, for example a polymer matrix composite material.
Example Ex6. An aerosol-generating device according to example Ex1 in which the side walls of the cavity are formed from a non-magnetic metallic material.
Example Ex7. An aerosol-generating device according to example Ex6 in which the side walls of the cavity are formed from a metal selected from the list consisting of aluminium, aluminium alloys, brass, copper, copper alloys, and non-ferromagnetic stainless steels.
Example Ex8. An aerosol-generating device according to any preceding example in which at least a portion of the side walls are formed from a radially-porous material.
Example Ex9. An aerosol-generating device according to example Ex8 in which the side walls have a longitudinal dimension extending away from the opening of the cavity, in which between 50% and 100% of the longitudinal dimension of the side walls is formed from a radially porous material.
Example Ex10. An aerosol-generating device according to any preceding example in which substantially all of the side walls are formed from a radially-porous material.
Example Ex11. An aerosol-generating device according to any of examples Ex8 to Ex10 in which the radially-porous material is a mesh or net.
Example Ex12. An aerosol-generating device according to any preceding example in which the side walls have a total porosity of between 40% and 95%, preferably between 50% and 90%, preferably between 60% and 80%.
Example Ex13. An aerosol-generating device according to any preceding example in which the cavity is substantially cylindrical.
Example Ex14. An aerosol-generating device according to any preceding example in which the side walls are substantially tubular.
Example Ex15. An aerosol-generating device according to any preceding example in which a transverse cross-section of the cavity is substantially circular.
Example Ex16. An aerosol-generating device according to any preceding example comprising a cavity base for supporting the aerosol-forming substrate, or an aerosol-generating article comprising the aerosol-forming substrate, when received in the cavity.
Example Ex17. An aerosol-generating device according to example Ex16 in which the cavity base is arranged to be longitudinally-movable within the side walls of the cavity.
Example Ex18. An aerosol-generating device according to example Ex17 in which the cavity base is longitudinally-movable between a first position and a second position, in which in the first position the cavity base is positioned closer to the opening of the cavity than in the second position.
Example Ex19. An aerosol-generating device according to any of examples Ex16 to Ex18 in which the cavity base is biased by a spring.
Example Ex20. An aerosol-generating device according to example Ex19 in which the cavity base is urged in a direction towards the opening by the spring.
Example Ex21. An aerosol-generating device according to any of examples Ex18 to Ex20 in which the device comprises a latch for releasably-retaining the cavity base in the second position.
Example Ex22. An aerosol-generating device according to any of examples Ex18 to Ex21 in which the device comprises a latch for releasably-retaining the cavity base in the first position.
Example Ex23. An aerosol-generating device according to any of examples Ex18 to Ex22 in which the first position is defined by a stop, the stop acting to prevent the cavity base from further movement towards the opening of the cavity.
Example Ex24. An aerosol-generating device according to example Ex23 in which the stop comprises a ledge defined by the side walls, or a projection extending radially from the side walls.
Example Ex25. An aerosol-generating device according to any preceding example in which the side walls have a proximal end towards the opening of the cavity and a distal end, the distal end of the side walls terminating in an end face or a cap.
Example Ex26. An aerosol-generating device according to example Ex25 in which a hole is defined through the end face or cap.
Example Ex27. An aerosol-generating device according to any of examples Ex16 to Ex26 in which the cavity base has a first surface facing the cavity opening and a second surface facing away from the cavity opening, in which the second surface is coupled with or connected to a push rod, the push rod extending away from the second surface.
Example Ex28. An aerosol-generating device according to example Ex27 when dependent on example Ex26 in which the hole in the end face or cap is dimensioned to allow the push rod to extend therethrough.
Example Ex29. An aerosol-generating device according to example Ex28 in which the push rod protrudes from a body of the device when an aerosol-forming substrate, or an aerosol-generating article comprising the aerosol-forming substrate, is positioned within the cavity.
Example Ex30. An aerosol-generating device according to any of examples Ex27 to Ex29 in which the cavity base and push rod form a manually actuatable ejector for facilitating removal of the aerosol-forming substrate from the cavity.
Example Ex31. An aerosol-generating device according to any preceding example configured to receive an aerosol-generating article comprising the aerosol-forming substrate and a susceptor for interacting with a fluctuating electromagnetic field generated by the induction coil to heat the aerosol-forming substrate.
Example Ex32. An aerosol-generating device according to any preceding example further comprising a removable mouthpiece, the removable mouthpiece being removeably attachable to the aerosol-generating device in a position covering the opening of the cavity.
Example Ex33. An aerosol-generating device according to any preceding example in which the at least one induction coil radially encircles a portion of the cavity.
Example Ex34. An aerosol-generating device according to any preceding example comprising a first induction coil and a second induction coil, both the first induction coil and the second induction coil being arranged to generate, in operation, a fluctuating magnetic field within the cavity.
Example Ex35. An aerosol-generating device according to example Ex34 in which the first induction coil is arranged to generate a fluctuating magnetic field within a first portion of the cavity and the second induction coil is arranged to generate a fluctuating magnetic field within a second portion of the cavity.
Example Ex36. An aerosol-generating device according to example Ex34 or Ex35 in which the first induction coil is configured to generate a first fluctuating magnetic field within the cavity, the first fluctuating magnetic field having first magnetic field properties, and the second induction coil is configured to generate a second fluctuating magnetic field within the cavity, the second fluctuating magnetic field having second magnetic field properties, the second magnetic field properties being different to the first magnetic field properties.
Example Ex37. An aerosol-generating device according to any preceding example in which the device further comprises a power source for supplying power to the at least one induction coil.
Example Ex38. An aerosol-generating device according to any preceding claim in which the device further comprises a controller configured to control power supply to the at least one induction coil.
Example Ex39. An aerosol-generating device according to any preceding example in which the device comprises a detector for detecting the presence of the aerosol-forming substrate, or an aerosol-generating article comprising the aerosol-forming substrate, within the cavity.
Example Ex40. An aerosol-generating device according to any preceding example in which the device is configured to operate with a first type of aerosol-generating article and a second type of aerosol-generating article different from the first type of aerosol-generating article, in which the first type of aerosol-generating article comprises an aerosol-forming substrate and a first susceptor configuration for heating the aerosol-forming substrate, and the second type of aerosol-generating article comprises an aerosol-forming substrate and a second susceptor configuration for heating the aerosol-forming substrate.
Example Ex41. An aerosol-generating device according to example Ex40 in which the first susceptor configuration and the second susceptor configuration differ in one or more susceptor parameters selected from the list consisting of susceptor material, susceptor shape, susceptor dimensions, and susceptor position relative to the aerosol-forming substrate.
Example Ex42. An aerosol-generating device according to example Ex41 in which the device is configured to detect which of the first type of aerosol-generating article and the second type of aerosol-generating article has been received in the cavity and control the at least one induction coil to produce a fluctuating magnetic field suitable for heating the susceptor of that type of aerosol-generating article.
Example Ex43. An aerosol-generating system comprising an aerosol-generating device as defined in any preceding example and an aerosol-generating article configured to be received within the cavity of the aerosol-generating device, the aerosol-generating article comprising;
an aerosol-forming substrate, and a susceptor for heating the aerosol-forming substrate when coupled with a fluctuating magnetic field generated by the induction coil of the aerosol-generating device.
Example Ex44. An aerosol-generating system according to example Ex43 in which the aerosol-generating article is in the form of a rod having a proximal end and a distal end, the distal end of the rod being dimensioned to be received in the cavity of the aerosol-generating device, the aerosol-forming substrate being located within the rod.
Example Ex45. An aerosol-generating system according to example Ex44 in which one or more susceptors are located internally within the rod for heating the aerosol-forming substrate.
Example Ex46. An aerosol-generating system according to example Ex45 in which the one or more susceptors are located radially centrally within the rod.
Example Ex47. An aerosol-generating system according to example Ex44 in which one or more susceptors is located at a radially outward portion of the rod.
Example Ex48. An aerosol-generating system according to example Ex45 or Ex46 in which one or more susceptors encircles a portion of the rod.
Example Ex49. An aerosol-generating system according to any of examples Ex45 to Ex48 in which an outer layer of the rod comprises one or more susceptors.
Example Ex50. An aerosol-generating system according to any of examples Ex45 to Ex49 in which the one or more susceptors are located in contact with the aerosol-forming substrate.
Example Ex51. An aerosol-generating system according to any of examples Ex43 to Ex50 in which the aerosol-generating article defines an air flow path extending between a distal end of the aerosol-generating article and a proximal end of the aerosol-generating article.
Example Ex52. An aerosol-generating system according to any of examples Ex43 to Ex51 in which at least a portion of an air flow path through the article extends between radial air inlets located between a distal end of the aerosol-generating article and a proximal end of the aerosol-generating article and an air outlet at the distal end of the aerosol-generating article.
Example Ex53. An aerosol-generating system according to any of examples Ex43 to Ex52 in which the aerosol-generating article is an elongated aerosol-generating article comprising an aerosol-forming substrate located within a housing or wrapper, and in which one or more holes or regions of porosity defined through the housing or wrapper allow radial air flow into the aerosol-generating article.
Example Ex54. An aerosol-generating system according to any of examples Ex43 to Ex53 in which the aerosol-forming substrate is a solid aerosol-forming substrate, for example an aerosol-forming substrate consisting of or comprising tobacco material.
Example Ex55. An aerosol-generating system according to any of examples Ex43 to Ex54 in which the in which the aerosol-forming substrate comprises a liquid aerosol-forming substrate, for example an aerosol-forming substrate comprising glycerine or propylene glycol.
Example Ex56. An aerosol-generating system according to any of examples Ex43 to Ex55 in which the aerosol-generating article is a disposable aerosol-generating article configured to be disposed of after a single use.
Example Ex57. An aerosol-generating system according to example Ex56 in which the aerosol-generating article comprises a plurality of components including the aerosol-forming substrate assembled within a wrapper in the form of a rod.
Example Ex58. An aerosol-generating system according to example Ex57 in which the aerosol-generating article comprises a susceptor located within the wrapper.
Example Ex59. An aerosol-generating system according to example Ex57 in which the wrapper comprises or consists of a susceptor.
Example Ex60. An aerosol-generating system according to any of examples Ex43 to Ex55 in which the aerosol-generating article comprises a reusable portion and a disposable portion, in which the reusable portion is in the form of a cartridge configured to be received in the cavity, the cartridge having a housing comprising a susceptor material and defining a cartridge cavity for receiving an aerosol-forming substrate, and in which the disposable portion comprises the aerosol-forming substrate.
Example Ex61. An aerosol-generating system according to example Ex60 in which the cartridge has a longitudinal dimension and a radial dimension, and one or more holes or regions of porosity are defined through walls of the housing to form one or more radial air inlets into the cartridge cavity.
Example Ex62. An aerosol-generating article configured for use with an aerosol-generating device according to any of examples Ex1 to Ex42.
Example Ex63. An aerosol-generating article for use with an aerosol-generating system according to any of examples Ex43 to Ex61.
Example Ex64. A method of generating an aerosol using an aerosol-generating device according to any of examples Ex1 to Ex42 or an aerosol-generating system according to any of examples Ex43 to Ex61, comprising the steps of;
locating an aerosol-generating article comprising an aerosol-forming substrate and a susceptor within the cavity of the aerosol-generating device, and
operating the at least one induction coil of the aerosol-generating device to generate a fluctuating magnetic field within the cavity, the fluctuating magnetic field coupling with the susceptor causing the susceptor to heat to an operating temperature, thereby heating the aerosol-forming substrate to form an aerosol.
Example Ex65. A method according to example Ex64, further comprising the step of drawing on a mouthpiece in fluid communication with the aerosol-forming substrate to inhale the aerosol.
Example Ex66. A method according to example Ex64 or Ex65 comprising the further step of ejecting the aerosol-generating article from the aerosol-generating device after use.
Example Ex67. A method according to any of examples Ex64 to Ex65 in which the cavity comprises a cavity base longitudinally-movable between a first position and a second position, in which in the first position the cavity base is positioned closer to the opening of the cavity than in the second position, the method comprising steps of inserting the aerosol-generating article into the cavity until it contacts the cavity base, applying pressure to move the cavity base from the first position to the second position, the second position being an operating position, and retaining the cavity base in the second position during generation of the aerosol.
Example Ex68. A method according to Ex67 comprising the step of ejecting the aerosol-generating article from the aerosol-generating device by moving the cavity base from the second position to the first position, the first position being an ejection position, thereby causing the aerosol-generating article to move in a direction towards the cavity opening.

Specific examples will now be further described with reference to the figures in which:

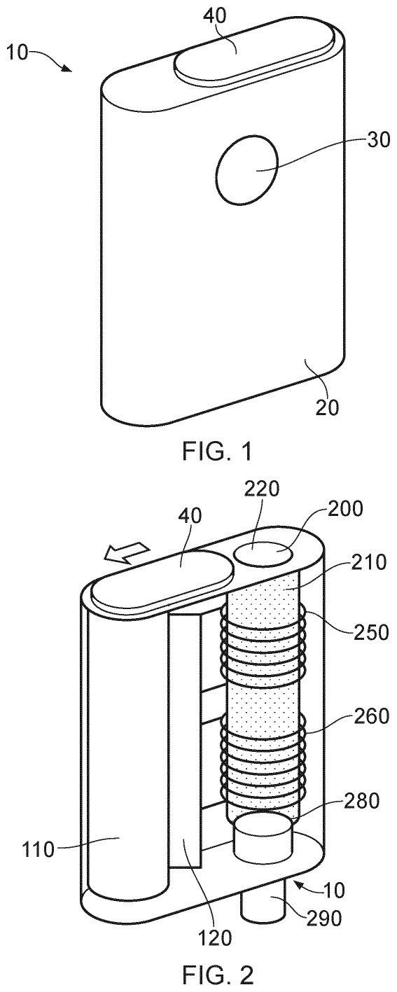

FIG. 1 shows a perspective view of an aerosol-generating device according to the present disclosure;

FIG. 2 shows a cut-away view of the aerosol-generating device of FIG. 1;

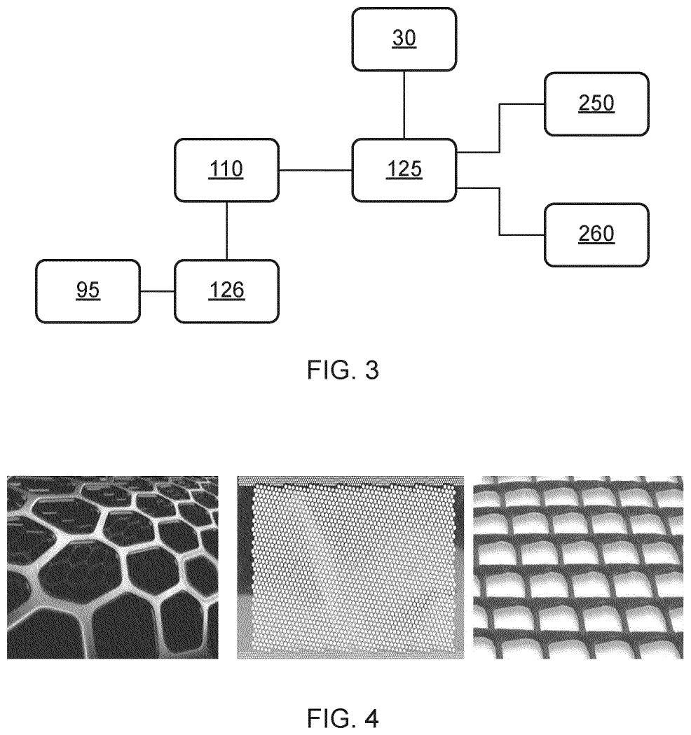

FIG. 3 shows a flow diagram indicating relationship between electronic components of the aerosol-generating device;

FIG. 4 illustrates examples of mesh configurations to be used to form an air permeable cavity of the aerosol-generating device;

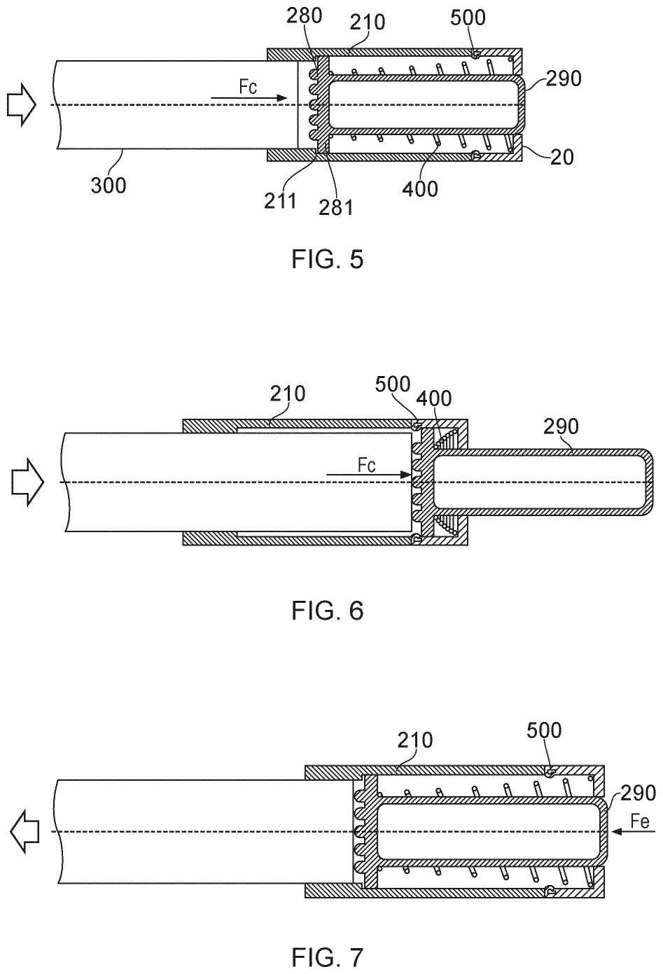

FIGS. 5, 6, and 7 illustrate insertion and extraction of an aerosol-generating article into the cavity of the aerosol-generating device;

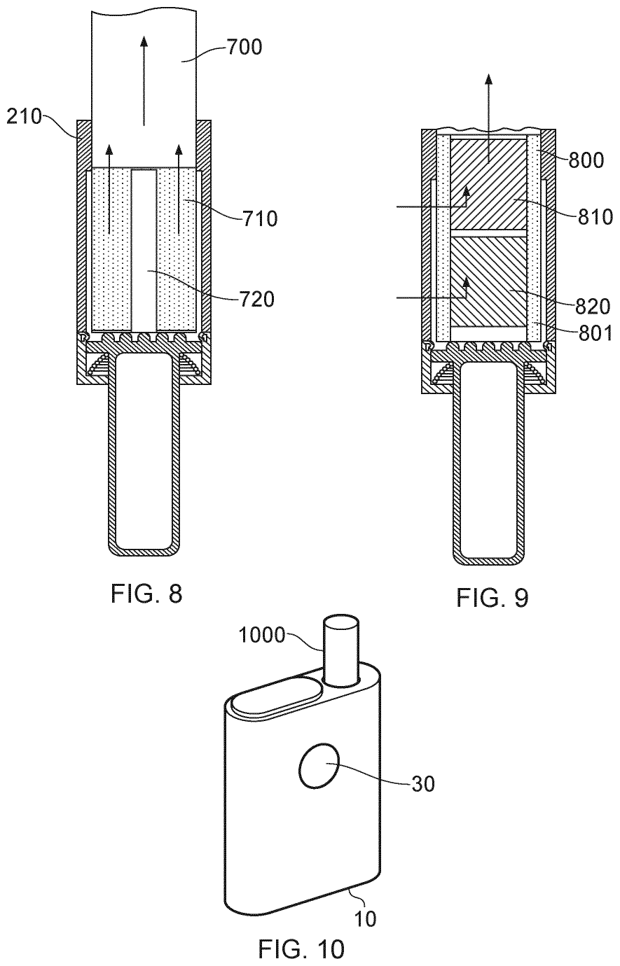

FIG. 8 shows a schematic illustration of the cavity of the device engaged with a disposable type aerosol-generating article comprising an internal susceptor;

FIG. 9 shows a schematic illustration of the cavity of the device engaged with a partially reusable type aerosol-generating article comprising an susceptor cartridge; and

FIG. 10 shows a perspective view of the aerosol-generating device with a removable mouthpiece attached.

FIG. 1 illustrates an aerosol-generating device according to a specific embodiment of the invention. The device 10 comprises a housing 20 locating a battery power source, a first induction coil, a second induction coil, electronics including a controller for controlling power from the battery to the first and second induction coils, and a cavity for receiving an aerosol-forming substrate. An operating button 30 is located on the housing 20. An opening to the cavity is closed by an openable cover 40.

FIG. 2 is a cut-away illustration of the aerosol-generating device 10 of FIG. 1. The battery 110 is located within a first portion of the housing along with the electronics 120. The electronics 120 include electronics 126 for controlling charging of the battery 110, a controller 125 for controlling power supplied to the first and second induction coils, and electrical connections between the battery 110, the induction coils, the operating button 30, and charging means, such as a charging port 95 defined through the housing.

The cavity 200 is located within a second portion of the cavity. The cavity 200 is defined by a tube 210 of polypropylene mesh having an opening 220 extending though the housing 20 to allow insertion and removal of an aerosol-forming substrate into the cavity. The openable cover 40 can be opened by a sliding action to expose the opening 220. The tube 210 of polypropylene mesh forms side walls of the cavity. An air inlet defined through the housing allows air into the second portion of the housing. The side walls of the cavity have a porosity of greater than 80%, effectively allowing unhindered radial airflow into the cavity.

An upper portion of the tube 210 is encircled by the first induction coil 250. The first induction coil 250 is coupled to the battery 110 via the controller and is configured to generate a fluctuating electromagnetic field within an upper portion of the cavity 200.

A lower portion of the tube 210 is encircled by the second induction coil 260. The first induction coil 250 is coupled to the battery 110 via the controller and is configured to generate a fluctuating electromagnetic field within a lower portion of the cavity 200.

A cavity base 280 is located at a lower end of the cavity 200. The cavity base 280 is arranged to slide longitudinally within the tube 210. A lower portion of the cavity base is coupled to a push rod 290, which extends through a hole defined through the housing so that it can be operated by a user to move the cavity base within the cavity. The cavity base and push rod form part of an extraction mechanism.

The arrangement of the electrical components of the aerosol-generating device is illustrated schematically in FIG. 3. The battery 110 is a rechargeable battery coupled to a charging port 95 via electronics 126 to control the charging of the battery. The charging port 95 can be any suitable charging port, for example a USB charging port. The battery 110 supplies power to operate the first induction coil 250 and the second induction coil 260. Power from the battery 110 is supplied to the first and second induction coils via a controller 125. The control electronics include an invertor to convert DC current supplied by the battery to AC current for supply to the first and second induction coils. The first and second induction coils may be operated independently or together. The controller 125 controls operation of the first and second induction coils in response to actuating signals provided by the user button 30. A memory may store one or more predetermined operating profiles to be implemented by the controller in response to signals from the operating button 30.

In use, a user uncovers the opening 220 of the cavity 200 by sliding the cover 40 to its open position. An aerosol-generating article comprising an aerosol-forming substrate and a susceptor is inserted into the cavity 200. The aerosol-generating article may be in the form of a fully disposable cylindrical aerosol-generating article comprising an aerosol-forming substrate and a susceptor located in thermal contact with the aerosol-forming substrate. The aerosol-generating article may be in the form of a cylindrical reusable cartridge containing a disposable aerosol-forming substrate. The reusable cartridge itself may form the susceptor.

The aerosol-generating article is inserted into the cavity 200 such that the susceptor of the article lies within a portion of the cavity subject to a fluctuating electromagnetic field when the device 10 is operated. The user actuates the device 10 using the operating button 30. The controller controls power to the induction coils to generate the fluctuating electromagnetic field. The susceptor is heated by the fluctuating electromagnetic field and, in turn, heats the aerosol-forming substrate to generate an inhalable aerosol. Power supplied to the induction coils is controlled to maintain the temperature of the aerosol-forming substrate within a predetermined range. When the usage session has ended, power supply to the induction coils is switched off. The user can then remove the aerosol-generating article from the cavity.

The side walls of the cavity are formed from an air permeable tube 210 of polypropylene mesh. The tube may be formed by taking a sheet of polypropylene mesh, rolling the sheet into a tube, and fixing touching ends of the sheet, for example by using a welding process or by adhesion. In other specific embodiments, the side walls of the cavity may be formed from a non-metallic metallic mesh tube, or an air permeable ceramic tube. A metallic tube, for example, may be formed by rolling a sheet of metallic mesh into a tube and fixing the touching ends, for example by welding. A ceramic tube may be formed by rolling a green ceramic mesh into a tube and firing to form an air-permeable ceramic tube. FIG. 4 illustrates mesh configurations that may be formed into a tube to form the side walls of the cavity. Air permeable tubes may also be formed by powder forming processes, for example by sintering powders of polymer, metal, or ceramic into an air-permeable tube.

FIGS. 5, 6, and 7 illustrate the cavity base 280 and the extraction mechanism in greater detail.

FIG. 5 illustrates the cavity base 280 and the extraction mechanism positioned for receiving an aerosol-generating article 300. The extraction base 280 is in the form of a plunger that is longitudinally slideable within the air permeable tube 210 forming the side walls of the cavity 200. The tube 210 is located by the housing 20. A spring 400 is located by the housing 20 and acts on a lower surface 281 of the cavity base 280 to urge the cavity base 280 towards the opening 220 of the cavity 200. The cavity base is urged against an internal ledge 211 defined within by the side walls 210 of the cavity. The internal ledge 211 prevents the cavity base 280 from further travel towards the opening 220 and defines a receiving position for the cavity base. A push rod 290 is connected to the lower surface 281 of the cavity base 280 and extends longitudinally therefrom and through a hole in the housing 20 dimensioned to accommodate a cross-section of the push rod 290. When the cavity base is located in the receiving position, an end of the push rod 290 lies flush with an outer surface of the housing.

When a user inserts the aerosol-generating article 300 into the cavity 200, a distal end of the article contacts the cavity base 280. By applying an insertion force (Fc) the distal end of the article pushes the cavity base into the cavity against the force of the spring 400. Elastic protrusions 500 extend into a lower portion of the cavity (either located by the side walls of the cavity or by the housing adjacent to a distal end of the side walls). As the cavity base is pushed towards a base of the cavity by the insertion force, the elastic protrusions deflect and allow the cavity base to pass. The elastic protrusions then regain their shape to latch the cavity base at the lower portion of the cavity. The elastic protrusions hold the cavity base in this position against the force of the, now compressed, spring 400. When the cavity base 280 is latched by the elastic protrusions 500 the cavity base 280 is in its operating position, with the aerosol-generating article located within the cavity to be heated. When the cavity base 280 is in the operating position (as illustrated in FIG. 6) the push rod 290 extends through the opening in the housing.

To extract the aerosol-generating article 300 after use, a user applies an extraction force (Fe) to the push rod 290. The extraction force needs to be sufficient to allow the cavity base 280 deflect the elastic protrusions 500 and travel longitudinally towards the opening 220 of the cavity 200. Once the cavity base 280 has travelled past the elastic protrusions 500, the spring 400 urges the cavity base back to the receiving position in which it is located by the internal ledge 211. Movement of the cavity base 280 back to the receiving position moves the aerosol-generating article back out of the opening 220 from where it may be removed.

Specific embodiments of the aerosol-generating device are intended to operate with different types of consumable. For example only, two different types of consumable are illustrated in FIGS. 8 and 9.

FIG. 8 illustrates a disposable aerosol-generating article 700 located within the cavity of the aerosol-generating device. The disposable aerosol-generating article is formed from a plurality of elements assembled within a cigarette paper to form a rod having a distal end and a mouth end. One of the elements of the rod is a plug of aerosol-forming substrate 710, which may be a gathered sheet of homogenised tobacco material. A strip of a susceptor material 720 is located within the plug of aerosol-forming substrate to heat the aerosol-forming substrate. When the device is operated and the susceptor heated, the user may draw on the mouthpiece of the aerosol-forming article. Air flows through the air permeable side walls 210 of the cavity, into the distal end of the rod, through the aerosol-forming substrate, and to the mouth of the user (arrows on FIG. 8 indicate airflow). After use, the entire aerosol-generating article 700 may be disposed of.

FIG. 9 illustrates a partially reusable aerosol-generating article 800 located within the cavity of the aerosol-generating device. The partially reusable aerosol-generating article 800 comprises a porous tubular cartridge 801 containing a first sachet of aerosol-forming substrate 810 and a second sachet of aerosol-forming substrate 820. The first and second sachets of aerosol-forming substrate are located coaxially within the tubular cartridge 801. The porous tubular cartridge 801 is formed from a magnetic stainless steel and acts as a susceptor to heat the aerosol-forming substrate located within.

In use, a user draws on a mouthpiece comprised in the aerosol-generating article 800 or a mouthpiece attachable to the aerosol-generating device 10. Air flows through the air permeable side walls 210 of the cavity and radially into the porous tubular cartridge 801. Thus, fresh air may flow into each of the first and second sachets of aerosol-forming substrate. The air, and aerosol generated by heating the substrates is drawn into the users mouth (arrows on FIG. 8 indicate air flow).

FIG. 10 illustrates an embodiment of the aerosol-generating device 10 with a removable mouthpiece 1000 attached over the opening to the cavity. The removable mouthpiece may be removed to allow insertion and removal of an aerosol-generating article, for example the article 800 described with reference to FIG. 9. The mouthpiece is preferably in the form of a tube formed from a polymer or a paper material and is intended to allow a user to draw aerosol from the aerosol-generating device in use. The removable mouthpiece 1000 may be dispensed with when a user consumes an aerosol-generating article that has its own integral mouthpiece, for example the aerosol-generating article 700 described with reference to FIG. 8.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±10% of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-13. (canceled)

14. An aerosol-generating device for generating an aerosol from an aerosol-forming substrate, the aerosol-generating device comprising:
a cavity having an opening configured to receive the aerosol-forming substrate, the cavity being defined by side walls extending away from the opening;
a cavity base configured to support the aerosol-forming substrate, or an aerosol-generating article comprising the aerosol-forming substrate, when received in the cavity, wherein the cavity base is arranged to be longitudinally movable within the side walls defining the cavity;
a push rod configured to move the cavity base, wherein the push rod protrudes from a body of the aerosol-generating device when the aerosol-forming substrate, or the aerosol-generating article comprising the aerosol-forming substrate, is positioned within the cavity; and
at least one induction coil located external to the cavity and arranged to generate a fluctuating magnetic field.

15. The aerosol-generating device according to claim 14, wherein the side walls of the cavity are formed from a non-susceptor material or a non-magnetic material.

16. The aerosol-generating device according to claim 14, wherein the side walls of the cavity are permeable to air thereby allowing a radial influx of air into the cavity through the side walls.

17. The aerosol-generating device according to claim 16,
wherein the side walls have a longitudinal dimension extending away from the opening of the cavity, and
wherein between 50% and 100% of a longitudinal dimension of the side walls is formed from a radially porous material.

18. The aerosol-generating device according to claim 14, wherein
substantially all of the side walls are formed from a radially porous material.

19. The aerosol-generating device according to claim 14,
wherein the cavity base is longitudinally movable between a first position and a second position, and
wherein in the first position the cavity base is positioned closer to the opening of the cavity than in the second position.

20. The aerosol-generating device according to claim 19, further comprising a latch configured to releasably retain the cavity base in the second position.

21. The aerosol-generating device according to claim 19, further comprising a latch configured to releasably retain the cavity base in the first position.

22. The aerosol-generating device according to claim 19, wherein the first position is defined by a stop, the stop acting to prevent the cavity base from further movement towards the opening of the cavity.

23. The aerosol-generating device according to claim 19,
wherein the cavity base has a first surface facing the cavity opening and a second surface facing away from the cavity opening, and
wherein the second surface is coupled with or connected to the push rod, the push rod extending away from the second surface.

24. The aerosol-generating device according to claim 19, wherein the cavity base and the push rod form a manually actuatable ejector configured to facilitate removal of the aerosol-forming substrate from the cavity.

25. The aerosol-generating device according to claim 14, wherein the cavity base is biased by a biasing element.

26. The aerosol-generating device according to claim 25, wherein the biasing element urges the cavity base in a direction towards the opening of the cavity.

27. The aerosol-generating device according to claim 14,
wherein the aerosol-generating device is configured to operate with a first type of aerosol-generating article and a second type of aerosol-generating article different from the first type of aerosol-generating article,
wherein the first type of aerosol-generating article comprises a first aerosol-forming substrate and a first susceptor configuration for heating the first aerosol-forming substrate, and
wherein the second type of aerosol-generating article comprises a second aerosol-forming substrate and a second susceptor configuration for heating the second aerosol-forming substrate.

28. An aerosol-generating system comprising an aerosol-generating device according to claim 14 and an aerosol-generating article configured to be received within the cavity of the aerosol-generating device, the aerosol-generating article comprising;
an aerosol-forming substrate, and a susceptor configured to heat the aerosol-forming substrate when coupled with a fluctuating magnetic field generated by the induction coil of the aerosol-generating device.
